(19) United States
(12) Patent Application Publication
(10) Pub. No.: US 2017/0361432 A1
(43) Pub. Date: Dec. 21, 2017

(54) POWER TOOL WITH TELESCOPIC OUTPUT SHAFT

(71) Applicant: ATLAS COPCO INDUSTRIAL TECHNIQUE AB, Stockholm (SE)

(72) Inventors: Karl Göran JOHANSSON, Saltsjö-Boo (SE); Wilhelm Mattias GEORGSSON, Trångsund (SE)

(73) Assignee: ATLAS COPCO INDUSTRIAL TECHNIQUE AB, Stockholm (SE)

(21) Appl. No.: 15/535,036

(22) PCT Filed: Aug. 11, 2015
(86) PCT No.: PCT/EP2015/068446

§ 371 Date: Jun. 10, 2017

(30) Foreign Application Priority Data
Dec. 10, 2014 (SE) 1451505-0

(51) Int. Cl. B25B 21/00; B25B 23/00; G01L 1/04; G01D 5/12

(52) U.S. Cl. CPC B25B 21/00; B25B 23/00; G01L 1/042; G01D 5/12

(57) ABSTRACT

A torque delivering power tool with a telescopically arranged output shaft includes a motor, a housing, an input shaft and an output shaft. A sensor is arranged to monitor an axial position of the output shaft with respect to the input shaft. The output shaft is telescopically arranged with respect to the input shaft between a fully extended position (P_{E}) and a fully compressed position (P_{C}). A resilient member having a known resilience in function of an extension is arranged to urge the output shaft towards the fully extended position (P_{E}), such that the extension of the output shaft continuously reflects a compression force acting between the output shaft and the input shaft. An indication unit is arranged to indicate an axial compression force acting between the output shaft and the input shaft based on a level of extension between the shafts.

The invention relates to a torque delivering power tool with a telescopically arranged output shaft. Specifically, the invention relates to such a tool with an improved functionality with respect to the interaction with a work piece. The invention is especially adapted to torque wrenches, i.e. power tools adapted to tighten and loosen screw joints.

### BACKGROUND

An operator holding a hand held torque delivering power tool should provide a moderate axial force to the power tool, such that the tool implement of the output shaft will stay in positive contact with the work piece and apply a positive force to the operation. Generally, if the tool implement is a drill bit the axial force needs to be relatively great in order to push the drill bit through the material.

If, on the other hand, the tool implement is a screw bit, the axial force should be sufficiently great so as to guarantee a good connection between the tool implement and the work piece, e.g. a bolt or screw, but at the same time it should not be so hard that the workpiece risks getting damaged.

For fixed tools it is also important to provide an axial force that is within an acceptable range. For fixed tools the axial force needs to be automatically adjusted throughout a torque delivering operation, whereas it will have to be manually supervised for a handheld tool.

The invention is based on the notion that there is a need of an arrangement for a power tool by means of which it is possible to control the axial force by which the output shaft acts on a work piece, while still allowing a certain flexibility concerning the axial position of the power tool.

### SUMMARY OF THE INVENTION

An object of the invention is to provide a torque delivering power tool by means of which it is possible to control the axial pressure at which the output shaft acts on the work piece.

This object is achieved by the invention according to claim 1, which relates to a torque delivering power tool with a telescopically arranged output shaft including:
a motor,
a housing,
an input shaft, which is driven by said motor,
an output shaft, which is rotationally connected to the input shaft and axially translatable with respect to the input shaft. A sensor is arranged to monitor an axial position of the output shaft with respect to the input shaft.

By monitoring the axial compression force acting between the output shaft and the input shaft it will be possible to control the axial force so as to continuously apply an axial compression force that is within a desired range.

In a specific embodiment of the invention the output shaft is telescopically arranged with respect to the input shaft between a fully extended position and a fully compressed position, wherein a resilient member having a known resilience in function of the extension is arranged to urge the output shaft towards the fully extended position, such that the extension of the output shaft continuously reflects the compression force acting between the output shaft and the input shaft.

With this specific embodiment it will be possible to uphold flexibility in the axial positioning of the tool, and still provide a axial force within a specific desired range.

Other features and advantages of the invention will be apparent from the figures and from the detailed description of the shown embodiment, and from the dependent claims.

### SHORT DESCRIPTION OF THE DRAWINGS

In the following detailed description reference is made to the accompanying drawings, of which:

FIG. 1 is a perspective view of a torque delivering power tool according to a specific embodiment of the invention with a telescopically arranged output shaft shown in a fully extended position;

FIG. 2 is a sectional view of a front part of the power tool shown in a fully extended position;

FIG. 3 is a perspective view of the torque delivering power tool shown in FIG. 1 with the telescopically arranged output shaft shown in a fully compressed position; and

FIG. 4 is a sectional view of a front part of the power tool shown in in a fully compressed position.

### DETAILED DESCRIPTION OF THE SHOWN EMBODIMENT OF THE INVENTION

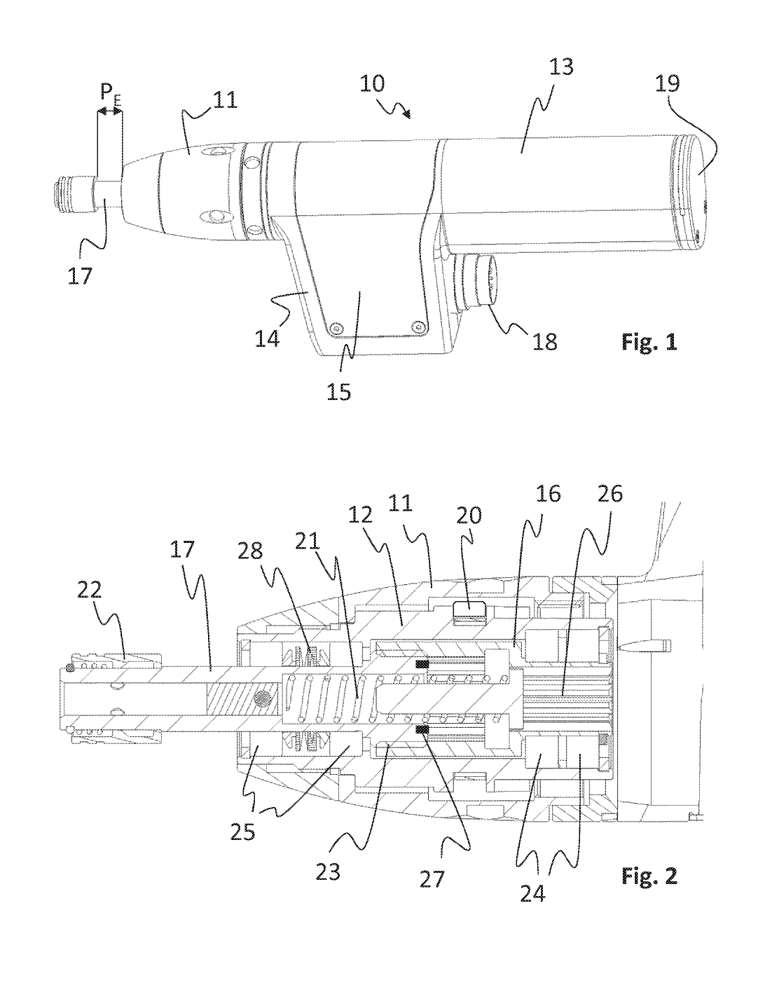

In FIG. 1 a torque delivering power tool 10 according to a specific embodiment of the invention is shown. In the shown embodiment the power tool is a power wrench adapted to tighten and loosen screw joints. This is a preferred embodiment of the invention.

The power tool 10 comprises a housing that comprises several parts, including a front housing part 11, a rear housing part 13, and between these two parts a frame housing part 14 with a hollow mid portion that is covered by a casing 15. The casing 15 may be removed to grant access to electronics housed inside the space enclosed by the casing 15 and the frame housing part 14.

A motor (not shown) is arranged in the rear housing part 13 and a gear portion may be arranged inside the upper part of the frame housing part 14 and casing 15. An output shaft 17, drivingly connected to the motor is partly housed inside the front housing part 11 and extends out from the same. In FIG. 1 the output shaft 17 is in a fully extended position P_{E}.

At a rear side of the frame housing part 14 a connection port 18 is arranged. The bottom of the housing part 14 includes a fixation element (not shown) for fixing the power tool 10 to a robot arm or the like. The shown embodiment of the power tool is an electric torque wrench and hence the connection port 18 includes connection pins for electric power and signalling. An indication unit 19, in the form of a light source, is arranged at a rear end of the rear housing part 13 in a position where it is clearly visible to the operator.

A front part of the power tool is shown in detail in a sectional view in FIG. 2. As is apparent from this view the power tool further comprises an input shaft 16. The input shaft 16 is driven by the motor (not shown) via motor gear 26. The motor gear 26 may be an integral part of a motor shaft is preferable driven by the motor via at least one reduction gear such as a planetary gear. Hence, preferably, the motor gear 26 is an output end of a reduction gearing. The output shaft 17 is rotationally connected to the input shaft 16 via a splined connection 23 and is journalled in bearings 25 with respect to an inner housing part 12. The bearings 25 includes a splined inside that allows the output shaft 17 to translate axially with respect to the bearings 25 and the inner housing 12.

A sensor 20 is arranged to monitor an axial compression force acting between the output shaft 17 and the input shaft 16. In the shown embodiment the sensor 20 monitors the axial position of the output shaft 17 with respect to the input shaft 16. A movement indicator 27 such as a magnet ring is located around an inner part of the output shaft 17. The sensor 20 is arranged to monitor the movement of the movement indicator 27 so as to deduce the axial position of the output shaft 17, and hence it's axial extension with respect to the housing 11. The sensor 20 may be a hall sensor, an inductive sensor, or a capacitive sensor indicating the axial extension between the output shaft 17 and the input shaft 16. The movement indicator 27 is adapted to the type of sensor used in a manner known in the art.

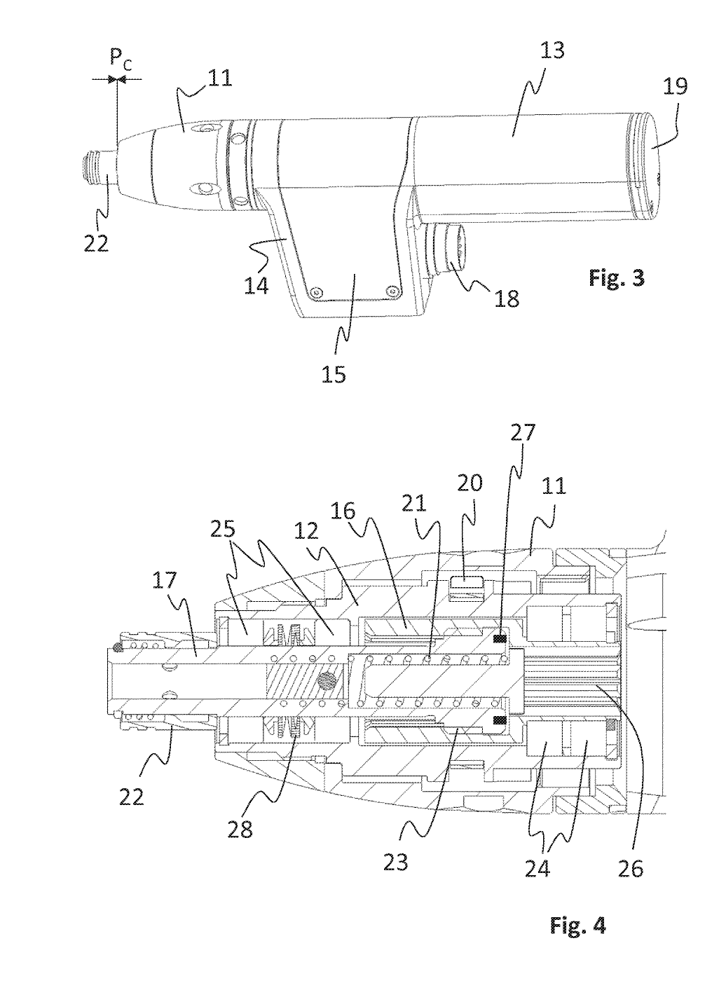

The output shaft 17 is telescopically arranged with respect to the input shaft 16 to allow axial movement of the output shaft 17 with respect to the input shaft 16 between a fully extended position P_{E} (shown in FIGS. 1 and 2) that corresponds to a minimum compression force and a fully compressed position P_{C} (shown in FIGS. 3 and 4) that corresponds to a maximum compression force.

A resilient member 21, e.g. in the form of a torsional spring and having a known resilience in function of its extension, is arranged to urge the output shaft 17 towards the fully extended position P_{E}, such that the extension of the output shaft 17 continuously reflects the compression force acting between the output shaft 17 and the input shaft 16. Thereby, it is possible to deduce the axial compression force acting between the output shaft 17 and the input shaft 16 from the axial position of the output shaft 17.

The indication unit 19 may be arranged to indicate the axial compression force acting between the output shaft 17 and the input shaft 16 based on the level of extension between the shafts. As an example the indication unit may emit a red light when the axial force is outside an allowable range. Further, to differentiate a too high axial pressure from a too low axial pressure, different colours may be dedicated to different states or rapid blinking light may be dedicated to the too high torque level, and slow blinking or a continuous light may be dedicated to the too low torque level. Also, the indication means may indicate a range inside which the level of extension between the shafts 16,17 corresponds to an acceptable compression force acting between the output shaft 17 and the input shaft 16. For example, a white light may be produced for as long as the axial force is inside the acceptable range, and at a the end of a successful tightening operation the light may switch to a green light.

The indication unit may also include a sound indicator that produces a typical sound such as a high frequency beat when the axial force is higher than the allowed axial force. Further, the indication unit may be located distant from the actual power tool, e.g. integrated in a control panel used for controlling the tool. In such a control panel data of different kinds may be selectively shown and stored in order to control tightening operations.

The torque delivering power tool 10 may comprise a control unit, which either may be located in the tool itself or in the control panel. The sensor 20 may be arranged to continuously during operation transmit the monitored axial compression force acting between the output shaft 17 and the input shaft 16 to the control unit, the control unit being adapted to deliver a signal to the indication unit 19 in order to indicate the axial compression force acting between the output shaft 17 and the input shaft 16.

The control unit is adapted to alert an operator of the tool, e.g. via the indication unit 19, if the axial force exceeds a predetermined upper threshold or if it reaches below a predetermined lower threshold.

The power tool 10 may further be configured to start a specific operation only when the level of extension of the output shaft 17 with respect to the input shaft 16 is within a predetermined range. An operation may also be interrupted if the axial force reaches below or above a certain threshold.

Above, the invention has been described with reference to a specific embodiment. The invention is however not limited to this embodiment. It is obvious to a person skilled in the art that the invention comprises further embodiments within its scope of protection, which is defined by the following claims.

1-8. (canceled)

9. A torque delivering power tool, with a telescopically arranged output shaft, the power tool comprising:
a motor;
a housing;
an input shaft driven by the motor; and
an output shaft rotationally connected to the input shaft and axially translatable with respect to the input shaft,
wherein:
a sensor is arranged to monitor an axial position of the output shaft with respect to the input shaft,
the output shaft is telescopically arranged with respect to the input shaft between a fully extended position (P_{E}) and a fully compressed position (P_{C}),
a resilient member having a known resilience in function of an extension is arranged to urge the output shaft towards the fully extended position (P_{E}), such that the extension of the output shaft continuously reflects a compression force acting between the output shaft and the input shaft, and
an indication unit is arranged to indicate an axial compression force acting between the output shaft and the input shaft based on a level of extension between the shafts.

10. The torque delivering power tool according to claim 9, wherein the indication unit comprises a scale that indicates a range within which the level of extension between the shafts corresponds to an acceptable compression force acting between the output shaft and the input shaft.

11. The torque delivering power tool according to claim 9, further comprising a control unit, and wherein the sensor, during operation, is arranged to continuously transmit the monitored axial compression force acting between the output shaft and the input shaft to the control unit, the control unit being adapted to deliver a signal to the indication unit in order to indicate the axial compression force acting between the output shaft and the input shaft.

12. The torque delivering power tool according to claim 11, wherein the control unit is adapted to alert an operator of the power tool via the indication unit if the axial force exceeds a predetermined upper threshold or if it reaches below a predetermined lower threshold.

13. The torque delivering power tool according to claim 9, wherein the sensor is a hall sensor, an inductive sensor, or a capacitive sensor indicating the axial extension between the output shaft and the input shaft.

14. The torque delivering power tool according to claim 10, wherein the sensor is a hall sensor, an inductive sensor, or a capacitive sensor indicating the axial extension between the output shaft and the input shaft.

15. The torque delivering power tool according to claim 11, wherein the sensor is a hall sensor, an inductive sensor, or a capacitive sensor indicating the axial extension between the output shaft and the input shaft.

16. The torque delivering power tool according to claim 12, wherein the sensor is a hall sensor, an inductive sensor, or a capacitive sensor indicating the axial extension between the output shaft and the input shaft.

17. The torque delivering power tool according to claim 9, wherein the power tool is configured to start a specific operation only when the compression force acting between the output shaft and the input shaft is within a predetermined range.

18. The torque delivering power tool according to claim 10, wherein the power tool is configured to start a specific operation only when the compression force acting between the output shaft and the input shaft is within a predetermined range.

19. The torque delivering power tool according to claim 11, wherein the power tool is configured to start a specific operation only when the compression force acting between the output shaft and the input shaft is within a predetermined range.

20. The torque delivering power tool according to claim 12, wherein the power tool is configured to start a specific operation only when the compression force acting between the output shaft and the input shaft is within a predetermined range.

21. The torque delivering power tool according to claim 13, wherein the power tool is configured to start a specific operation only when the compression force acting between the output shaft and the input shaft is within a predetermined range.

22. The torque delivering power tool according to claim 14, wherein the power tool is configured to start a specific operation only when the compression force acting between the output shaft and the input shaft is within a predetermined range.

23. The torque delivering power tool according to claim 15, wherein the power tool is configured to start a specific operation only when the compression force acting between the output shaft and the input shaft is within a predetermined range.

24. The torque delivering power tool according to claim 16, wherein the power tool is configured to start a specific operation only when the compression force acting between the output shaft and the input shaft is within a predetermined range.
